(19) United States
(12) Patent Application Publication
(10) Pub. No.: US 2025/0045395 A1
(43) Pub. Date: Feb. 6, 2025

(54) MATCHING COMMANDS TO ATTACK PATTERNS

(71) Applicant: RED HAT, INC., Raleigh, NC (US)

(72) Inventors: Andrea Cosentino, Rome (IT); Paolo Antinori, Novara (IT)

(21) Appl. No.: 18/362,654

(22) Filed: Jul. 31, 2023

(51) Int. Cl. G06F 21/56

(52) U.S. Cl. CPC G06F 21/566; G06F 2221/034

(57) ABSTRACT

A method may include identifying, by a processing device, a sequence of commands received within a specified time window; responsive to matching at least part of the sequence of commands to a predefined attack pattern of a plurality of predefined attack patterns, identifying a first action regarding a process associated with the at least part of the sequence of commands; and performing the first action.

### TECHNICAL FIELD

The disclosure is generally related to networking computing systems, and is more specifically related to matching commands to attack patterns.

### BACKGROUND

In networks and communication and information systems, attacks can include intrusions performed by malicious agents, attacks on operating systems and applications, crypto-jacking, and malware attacks. Currently, attacks involves complex scenarios due to the heterogeneity of technologies, the virtualization of networks, and the growing sophistication of attack techniques.

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 depicts a high-level diagram of an example system architecture operating in accordance with one or more aspects of the disclosure;

FIG. 2 depicts an example for a command collected through a command collecting component, in accordance with one or more aspects of the disclosure;

FIG. 3 depicts a flow diagram of an example method for presetting for attack pattern matching for commands, in accordance with one or more aspects of the disclosure;

FIG. 4 depicts a flow diagram of an example method for implementing attack pattern matching for commands, in accordance with one or more aspects of the disclosure; and

FIG. 5 depicts a block diagram of an example computer system, in accordance with one or more aspects of the disclosure; and

FIG. 6 depicts a block diagram of an illustrative computing device operating in accordance with the examples of the disclosure.

### DETAILED DESCRIPTION

Implementations of the disclosure are directed to matching commands to attack patterns. An attack on a system can include a series of operations that are spread over time and can be difficult to predict. Some attacks may follow a logic in terms of temporal sequence, which can be summarized as an attack pattern. An attack pattern can be a reliable sample of an isolated action (single-phase attack pattern) or a sequence of several actions to capture and represent an attacker's perspective and knowledge in detail of how attacks are carried out in terms of the conditions and sequences. For example, an attack pattern can be considered as a reliable sample of a sequence of actions that aim to discover vulnerabilities in deployed systems and applications and subsequently exploit them without leaving a trace.

Identifying an attack pattern may consume extensive resources and need extensive time. In some systems, a network traffic analysis is implemented to monitor the network activity and identify security and operational issues. However, to trace an attack pattern, writing or modifying codes at the kernel level or run programs in the kernel space is required, which is not easy to be implemented nor resource efficient. None of these systems can trace and use an attack pattern at a user space level.

Aspects of the disclosure address the above and other deficiencies by implementing attack pattern matching for commands collected at a user space level. The collected commands can be compared with a dataset including predefined attack patterns to find a match of at least part of the collected commands to a predefined attack pattern. When a match is found, certain actions can be taken to mitigate the impact caused by these commands.

In one implementation, a component of a computer system (referred to as a command collecting component which can be implemented as one or more software modules running in the computer system) can collect the commands, for example, by tracing the return of a function, where the return shows the commands that were entered in the computer system. For example, the command collecting component can include an extended Berkeley packet filter (eBPF). eBPF is a technology that can run isolated programs in a privileged context such as the operating system kernel, and is used to extend the kernel functionality safely and efficiently without requiring to change the kernel source code or load the kernel modules.

Another component of the computer system (referred to as an attack detection component which can be implemented as one or more software modules running in the computer system) may identify one or more command interfaces to collect commands by the command collecting component. The attack detection component may determine (e.g., arbitrarily or by using a default value) a time window for collecting commands received through the command interface(s). The attack detection component may intercept a sequence of commands received through the command interface(s) during the time window. For example, the attack detection component may identify all command interfaces (such as CLI, API, etc.) associated with the computer system and employ the command collecting component to collect the sequence of command received by each identified command interface during a specified time window. In some implementations, collecting the commands does not affect the process of executing the commands, and thus the commands can be executed regardless of operation of the command collecting component.

Upon collecting the commands during the time window, the attack detection component may determine that at least a part of the collected sequence of commands matches a predefined attack pattern. The attack pattern may be represented by a data structure that includes name, type, description, intended result of the attack, participants, steps of the attack, dependencies and conditions, sample code of the attack, mitigation strategies (e.g., recommended actions), related attacks, etc. The predefined attack pattern may be stored in a dataset which can include multiple records, such that each record corresponds to a predefined attack pattern. Thus, the attack detection component may determine that at least part of the collected commands matches the predefined attack pattern by using a representative parameter of the predefined attack pattern.

For example, in one embodiment, the attack detection component may employ a machine-learning model to transform a sequence of commands of a known (e.g., previously recorded) attack corresponding to an attack pattern to a numeric vector encoding the features of the attack (“attack fingerprint”), where the attack fingerprint is a representative parameter of the attack pattern. The attack detection component can store the representative parameter in the record corresponding to the attack pattern in the dataset. Thus, the dataset can store multiple attack fingerprints, each corresponding to an attack pattern. The attack detection component may employ the same machine-learning model to transform the collected commands (e.g., each sequence of the commands in the collected commands) to respective feature vectors. The attack detection component can then search the dataset by comparing the feature vectors to the attack fingerprints. If the attack detection component determines that the difference between one of the feature vectors and an attack fingerprint of the attack pattern is below a threshold value, the sequence of the commands that has been transformed to that feature vector is found to match the attack pattern. For example, the difference between two vectors may be found by using Euclidian distance. In the illustrated example, although the representative parameter is described as a numeric vector called attack fingerprint, other forms of representative parameter can be also applicable.

As described above, the attack detection component may find a match of the commands collected by the command collecting component with the predefined attack patterns stored in the dataset. Although the neural network model is described above, other methods can be used to find a match, such as machine learning, text matching, graph matching, etc.

In some implementations, responsive to determining that a sequence of commands matches a predefined attack pattern, the attack detection component may determine a process-level remedial action regarding the ongoing process or device involved during or after executing the matched commands. For example, matched commands may enable the system to transmit a data packet to a third party, and the process-level remedial action is directed to the transmitting process. (e.g., by stopping the transmitting process). The process-level remedial action may include blocking the process associated with the matched commands, isolating the device associated with the matched commands, or no other action but continuing collecting commands in the command interface. The attack detection component may perform the process-level remedial action.

In some implementations, responsive to determining that a sequence of commands matches a predefined attack pattern, the attack detection component may determine a severity level of the attack pattern and, in view of the severity level, perform a system-level remedial action regarding the attack. The severity level may be represented by a value that reflects the severe state of the result of the attack and corresponds to a system-level remedial action. For example, a first value may represent a high severity level and correspond to a system-level remedial action of isolating the device associated with the matched commands and sending a notification regarding the severity level to a user device; a second value may represent a medium severity level and correspond to a system-level remedial action of monitoring the process associated with the matched commands and sending a notification regarding the severity level to a user device; a third value may represent a low severity level and correspond to a system-level remedial action of sending a notification regarding the severity level to a user device.

The attack detection component may record the matched sequence of commands and the matched attack pattern and store the new record in the local or remote dataset. The dataset associated with the predefined attack pattern can be expanded to include new matched commands, which can be used for future pattern matching. By continuing collecting commands received by each command interface of the computer system for a time window, the attack detection component can constantly find the matched attack pattern and update the local or remote dataset for the attack patterns.

Advantages of the present disclosure include improving efficiency of identifying an attack by the usage of attack pattern matching. The techniques disclosed herein may provide a tool used in a user space to collect data at a device for the attack analysis, where a kernel executes an attack pattern matching without the need to modify the application being traced or generate overhead for resource consumption, thereby increasing efficiency of a computer system by reducing power consumption and processor (e.g., central processing unit (CPU)) cycles. Further, the newly matched commands can be used to expand the dataset of predefined attack patterns for enhanced identifying the attack.

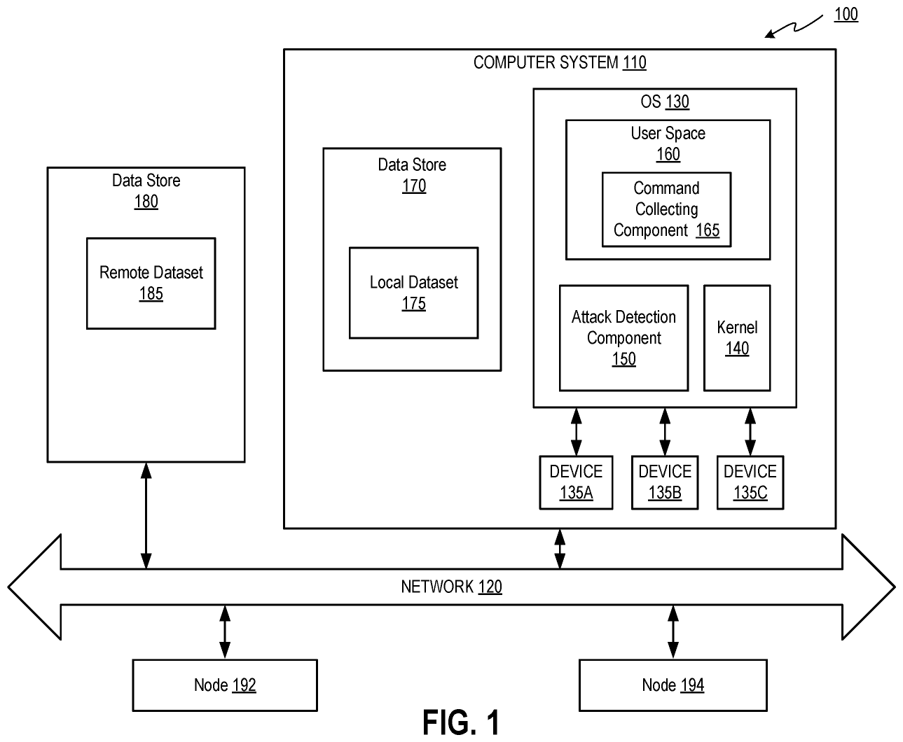

FIG. 1 illustrates an example system architecture 100 in which implementations of the disclosure may operate. The system architecture 100 may include a computer system 110, a data store 180, a node 192, and a node 194 coupled via a network 120. In one example, the computer system 110, the node 192, and the node 194 may be host systems in a cluster in a data center. In another example, the computer system 110 may be a host system and the node 192 and the node 194 may be virtual machines, hypervisors, and/or devices (e.g., virtual and/or physical network interface controllers (NICs)) running on the computer system 110 or another computer system. The network 120 may be a public network (e.g., the Internet), a private network (e.g., a virtual local area network (vLAN), a local area network (LAN), or a wide area network (WAN)), or a combination thereof. The network 120 may include a wireless infrastructure, which may be provided by one or more wireless communications systems, such as a wireless fidelity (WiFi) hotspot connected with the network 120 and/or a wireless carrier system that can be implemented using various data processing equipment, communication towers, etc. Additionally, or alternatively, the network 120 may include a wired infrastructure (e.g., Ethernet).

In some implementations, the system architecture 100 includes one or more cloud-computing environment (also referred to as a cloud(s)) that includes nodes to execute applications and/or processes associated with the applications. A node providing computing functionality may provide the execution environment for an application of the system. In some implementations, the “node” may include a virtual machine that is hosted on a physical machine, such as host implemented as part of the clouds. For example, nodes are hosted on physical machine of host in cloud provided by one or more cloud service provider systems. In some implementations, nodes may additionally or alternatively include a group of VMs, a container, or a group of containers to execute functionality of the applications.

The computer system 110 may comprise one or more processing devices communicatively coupled to memory devices (e.g., data store 170) and devices 135A-C (e.g., input/output (I/O) devices, compact disc read-only memory (CD-ROM) drive, physical NICs, etc.). The computer system 110 may be a server, a mainframe, a workstation, a personal computer (PC), a laptop, a mobile phone, a palm-sized computing device, or any suitable computing device. The computer system 110 runs an operating system (OS) 130, which is an application that manages the hardware resources of the computer system 110 and that provides functions such as interprocess communication, scheduling, memory management, and so forth.

The OS 130 may include and execute a kernel 140. In some implementations, a kernel may also be referred to as a supervisor or supervisor component. The kernel is a computer program that is the core of the OS 160. The critical code of the kernel is usually loaded into a separate area of memory, which is protected from access by application programs or other, less critical parts of the OS 160. The kernel performs its tasks, such as running processes, managing hardware devices such as the hard disk, and handling interrupts, in this protected kernel space.

In one implementation, the kernel is a hypervisor. A hypervisor may refer to an application that provides a virtual operating platform for a set of virtual machines (VMs). Each VM of the set of VMs may be in a user space (e.g., user space 160) of computer system 100. The hypervisor abstracts the physical layer of the computer system 110, including the processors, memory, I/O devices, network devices, and presents this abstraction to the VMs. The hypervisor may create, run, manage, and monitor various aspects of virtual machines operation, including the processing, and storage, memory, and network interfaces. The VMs may be implemented in computer instructions that emulate physical machines and may execute applications as though they were an actual physical machine. For example, a VM executes a guest operating system that may utilize the underlying virtual devices, including virtual processors, virtual memory, virtual I/O devices, and virtual NICs.

The OS 130 may include and execute a user space 160. The user space may refer to codes that runs outside of the kernel 140. In some implementations, the user space may include application programs including browsers, word processors, audio or video players, or virtual machines (VMs) and use a separate area of memory. The specification between the kernel 140 and the user space 160 prevents user data and kernel data from interfering with each other and causing instability and slowness, as well as preventing malfunctioning in the user space 160 from crashing the entire OS 130.

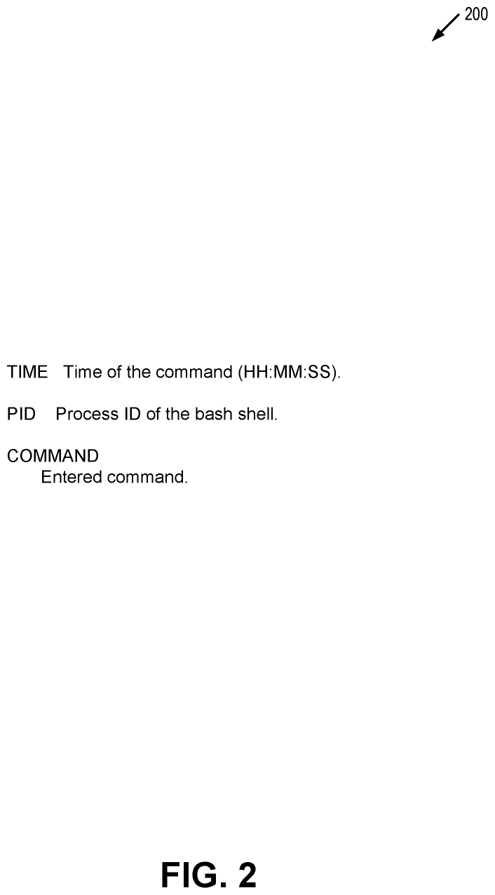

In some implementations, the user space 160 may include a command collecting component 165. In one implementations, the command collecting component 165 is one of a set of tools using eBPF (e.g., BPF Compiler Collection (BCC) and bpftrace) that can create efficient kernel tracing and manipulation programs. In some implementations, the command collecting component 165 traces the return of a function (e.g., readline( ) function) (e.g., using uprobes), where the function shows the commands (e.g., bash commands) that were entered in the system. FIG. 2 illustrates an example of showing a command entered in a shell through the command collecting component 165. The shell refers to a computer program that exposes an operating system's service to a user or other programs, for example, through a command-line interface (CLI). As shown in FIG. 2, the time of the command is recorded, and the process identifier of the command can be used to identify the process. Additional information of the command that can be used to find an attack pattern match can be shown, including command type, source identifier, destination identifier, etc.

Referring back to FIG. 1, in some implementations, the OS 130 may include an attack detection component 150. The attack detection component 150 may identify a device (e.g., device 135A-C) in the computer system 110 and determine a time window for collecting commands, obtain, through the command collecting component 165, a set of commands associated with the device during the time window, determine a pattern match of the set of commands to a predefined attack pattern in a dataset, and perform an action based on the pattern match. The detail of these operations will be described below.

Specifically, the attack detection component 150 may identify a device 135A-C for collecting commands. The device can be node 192, node 194, virtual machines, hypervisors, and/or devices (e.g., virtual and/or physical network interface controllers (NICs)) running on the computer system 110 or another computer system. The attack detection component 150 may identify the device through a device identifier. The attack detection component 150 may identify one or more shells associated with the device 135A-C.

The attack detection component 150 may determine, arbitrarily or by a default value, a sliding time window to be used for collecting commands. The attack detection component 150 may enable the command collecting component 165 to collect the data, i.e., the sequence of commands received by each identified shell of the identified device 135A-C during the time window. In some implementations, the attack detection component 150 enables the command collecting component 165 to select the data collected during a sliding time window as a first collection of data and moves to the next time window to select the data collected during the new time window as a second collection of data. The time window may be defined as an amount of time. For example, the attack detection component 150 may start the command-collection process at a time point TO, where a time window defines the duration t1, and the attack detection component 150 may determine that at time point T1 the duration t1 has elapsed and wrap up the collected data. The attack detection component 150 may continue the command-collection process using a start time at time point T1 and wrap up the data at time point T2 for another duration t1 has elapsed from T1 to T2. In some implementations, the command collecting component 165 sends, to the attack detection component 150, all commands received by each shell at a predefined time interval, and the attack detection component 150 retrieve, for a specific time window, commands received by each identified shell of the identified device (assuming the time window is less than the predefined time interval). In some implementations, the attack detection component 150 sends, to the command collecting component 165, the information regarding the identified device, the identified shells, and the time window, and the command collecting component 165 collect the data accordingly and send, to the attack detection component 150 sequence of commands received by each identified shell of the identified device for the time window.

The attack detection component 150 may access a data store 180, 170 for a predefined attack pattern and determine a match of part of the collected commands to the predefined attack pattern. The predefined attack pattern may be stored in the remote dataset of the data store 180 or in the local dataset of the data store 170. A remote dataset 185 or a local dataset 175 can include multiple records, and each record corresponds to a predefined attack pattern. In some implementations, each record may include a representative parameter of the attack pattern. In some implementations, a set of records can correspond to a same predefined attack pattern, and in such cases, the set of records can be grouped together or can be consolidated as a list for one predefined attack pattern. In some implementations, each record may record a single command or a sequence of commands that has been found to match the attack pattern and further include parameters associated with each command.

Data store 180 or 170 may include any data storage that is capable of storing digital data, such as physical memory devices including volatile memory devices (e.g., RAM), non-volatile memory devices (e.g., NVRAM), other types of memory devices, or a combination thereof. Data store 180 or 170 may include mass storage devices, such as solid-state storage (e.g., Solid State Drives (SSD)), hard drives, other persistent data storage, or a combination thereof. Data store 180 or 170 may be located in data centers.

For example, if the local dataset 175 of the data store 170 does not include a predefined attack pattern, the attack detection component 150 may access to the remote dataset 185 of the data store 180 for the predefined attack pattern. In some implementations, the remote dataset 185 or the local dataset 175 can be prepared with well-known sequenced commands for an attack pattern. For example, a single command for a sudden change of permission and ownership in all filesystems can be interpreted as an attack pattern. In another example, a sequenced commands for change of permission and ownership in all filesystems can be interpreted as an attack pattern.

To find a match, the attack detection component 150 may compare the sequence of commands collected by the command collecting component with the information associated with a predefined attack pattern stored in the dataset. The method used for comparing to find a match can include machine learning, text matching, graph matching, etc. In some implementations, the attack detection component 150 may set a default pattern matching approach, for example, machine learning, text matching, or graph matching.

In some embodiments, the attack detection component 150 may implement a machine learning model for the pattern matching approach. The machine learning model can be trained on a number of datasets that may include datasets representing attack patterns. The machine learning model can be based on one or more neural network models, can include multiple neuron layers, and can be trained prior to being used by the attack detection component 150. The machine-learning model takes a sequence of commands as an input and output an attack pattern.

To train the machine-learning model to find a pattern match, training datasets are generated, for example, by labeling a sequence of commands with an identifier of an attack pattern (or a group of attack patterns belongs to an attack type). During the training phase, the machine-learning model can process the sequence of commands to output a predicted attack pattern (represented by an identifier) and compare the predicted attack pattern with the labeled attack pattern specified by the training metadata (e.g., an identifier of an attack pattern or a group of attack patterns). Based on the comparison result, one or more parameters of the machine-learning model can be adjusted.

A training can further establish input-output associations between training inputs and the corresponding target output. In establishing the input-output associations, the training can use algorithms of grouping and clustering, such as the density-based spatial clustering of applications with noise (DBSCAN) algorithm, or similar algorithms. As such, the machine learning model can develop associations between a particular set of sequenced commands and a labeled attack pattern. Then, during identifying (testing) phase, the trained machine learning model can receive, as an input, a sequence of commands, and identify, as an output, the attack pattern.

In some embodiments, the attack detection component 150 may implement a text matching model for the pattern matching approach. In some implementations, the text matching model can estimate the semantic similarity between the collected commands and recorded commands associated with an attack pattern. The text matching model can compare the sequence of commands with a particular sequence of commands corresponding to a predefined attack pattern stored in the dataset. In some embodiments, the attack detection component 150 compares the sequence of commands with each of the particular sequences of commands corresponding to predefined attack patterns stored in the dataset, and responsive to find a match under the text matching model, output the predefined attack pattern of the matched particular sequences of commands. In some embodiments, the text matching model can take the sequence of commands and the particular sequences of commands as input and predict the probability of the sequence of commands matching the particular sequences of commands.

In some embodiments, the attack detection component 150 may implement a graph matching model for the pattern matching approach. The graph matching model can estimate the graph similarity between a graph generated by collected commands and a graph corresponding to a target attack pattern. The graph matching model can compare a graph generated by the sequence of commands with a graph corresponding to a predefined attack pattern stored in the dataset. In some embodiments, the attack detection component 150 compares a graph generated by the sequence of commands with each of the graphs corresponding to predefined attack patterns stored in the dataset, and responsive to find a match under the graph matching model, output the predefined attack pattern of the matched graph. In some embodiments, the graph matching model can take a graph generated by the sequence of commands and a graph corresponding to a predefined attack pattern as input and predict the probability of a graph generated by the sequence of commands matching a graph corresponding to a predefined attack pattern. In some embodiments, the graph matching model can use various algorithms for graph similarity.

In some implementations, responsive to determining no match of the sequence of commands with a predefined attack pattern, the attack detection component 150 may take no action. In some implementations, responsive to determining a match of the sequence of commands with a predefined attack pattern, the attack detection component 150 may determine a process-level remedial action regarding the ongoing process or device involved during or after executing the matched commands and perform the process-level remedial action. The process-level remedial action may include blocking the process associated with the matched commands, isolating the device associated with the matched commands, or no other action but continuing collecting commands in the shell. In some implementations, the value indicating the process-level remedial action is stored with the predefined attack pattern in the dataset, for example, in metadata. In some implementations, the attack detection component 150 may select a value from a set of predefined values indicating the process-level remedial actions.

In some implementations, responsive to determining a match of the sequence of commands with a predefined attack pattern, the attack detection component 150 may determine a severity level of the attack pattern and perform a system-level remedial action corresponding to the severity level. The severity level may be represented by a value that reflects how bad or serious the result of the attack could be and corresponds to a system-level remedial action. For example, a first value may represent a high severity level and correspond to a system-level remedial action of isolating the device associated with the matched commands received by the shell and sending a notification regarding the severity level to a user device; a second value may represent a middle severity level and correspond to a system-level remedial action of monitoring the process associated with the matched commands and sending a notification regarding the severity level to a user device; a third value may represent a low severity level and correspond to a system-level remedial action of sending a notification regarding the severity level to a user device. In some implementations, the value of severity level is stored with the predefined attack pattern in the dataset, for example, in metadata, and the attack detection component 150 may retrieve the value. In some implementations, the attack detection component 150 may select a value from a set of predefined values of severity levels based on a field of the predefined attack pattern, for example, a type of the attack. In some implementations, isolating the device may include disconnecting the device from network, turning off the device (e.g., when disconnecting the device from network is not feasible), or sending multiple alarm notifications to the user device (e.g., when turning off the device is not feasible). In some implementations, the attack detection component 150 may reconcile the process-level remedial action regarding the process and the system-level remedial action corresponding to a severity level and perform the action with a better security level. In some implementations, multiple matches of predefined attack patterns can be found for the commands collected by the command collecting component during the time window, and in such cases, the attack detection component 150 can perform the process-level remedial action and/or the system-level remedial action for each of the predefined attack pattern.

The attack detection component 150 may record the matched sequence of commands and the matched attack pattern and store the new record in the local dataset 175 of the data store 170 or the remote dataset 180 of the data store 180. The new record can be additional dataset that is used for future pattern match. In some implementations, the attack detection component 150 may build a dataset using the new records. As the attack detection component 150 can continue collecting commands received by each shells of the device for a time window periodically, the attack detection component 150 can constantly find the matched attack pattern and update the local or remote dataset for the predefined attack pattern.

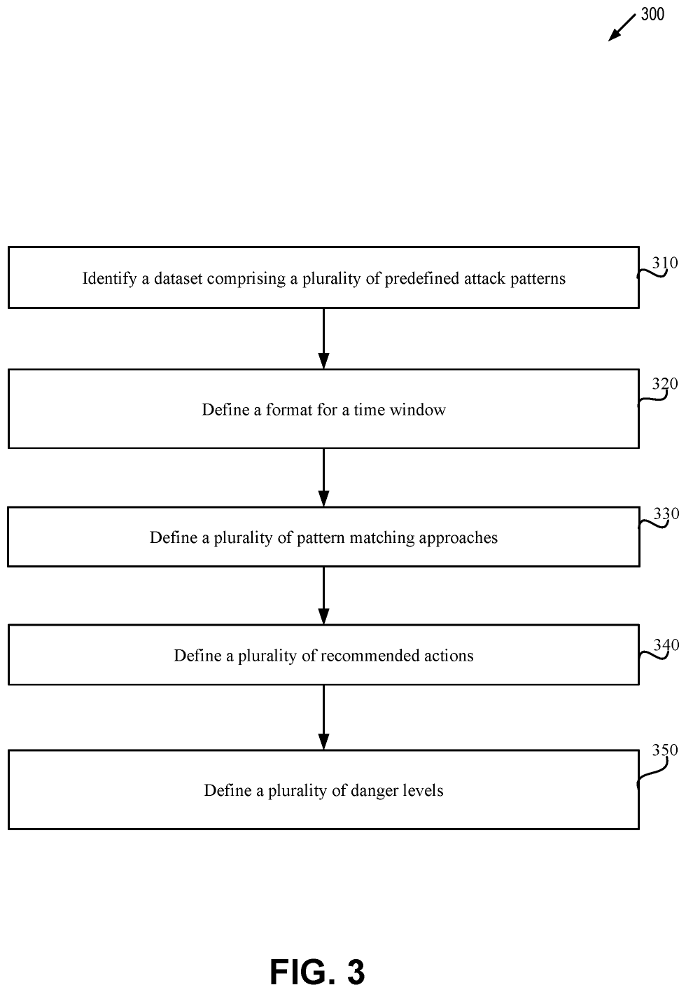

In some implementations, to implement the processes described above, the attack detection component 150 may need to preset and define a set of parameters used in the processes, for example, the dataset including multiple predefined attack patterns, the format for the time window, the pattern matching approaches (e.g., machine learning, text matching, graph matching, etc.), the process-level remedial actions, or the severity levels, etc. The detail of the presetting of the parameters is described with respect to FIG. 3.

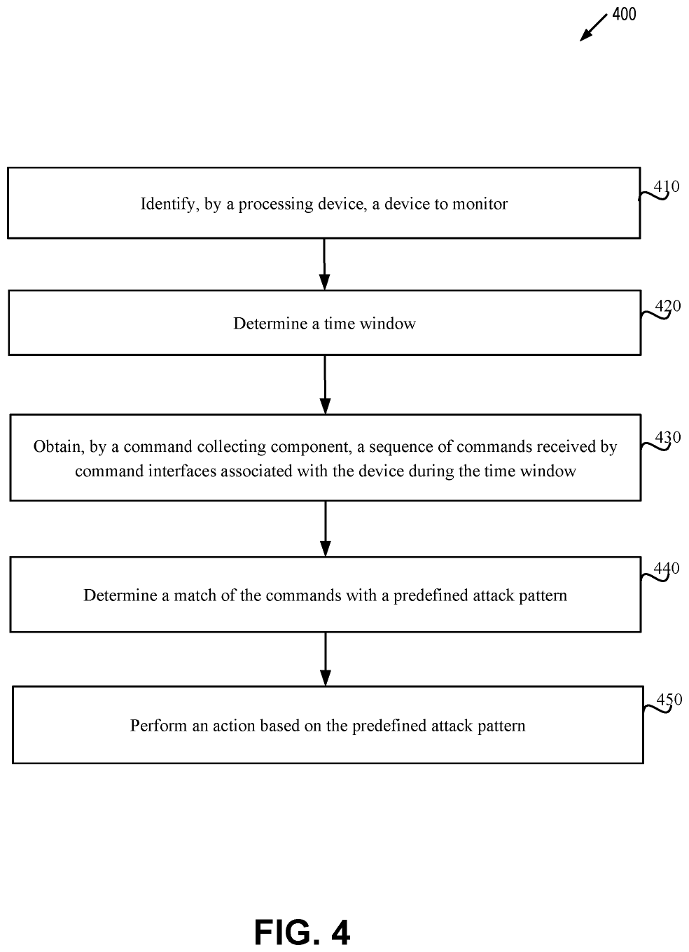

FIGS. 3 and 4 depicts flow diagrams of example methods for presetting for and implementing attack pattern matching for commands collected through a command collecting component, in accordance with one or more aspects of the present disclosure. Methods 300 and 400 and each of its individual functions, routines, subroutines, or operations may be performed by one or more processing devices of the computer device executing the method. In certain implementations, methods 300 and 400 may be performed by a single processing thread. Alternatively, methods 300 and 400 may be performed by two or more processing threads, each thread executing one or more individual functions, routines, subroutines, or operations of the method. In an illustrative example, the processing threads implementing method 200 may be synchronized (e.g., using semaphores, critical sections, and/or other thread synchronization mechanisms). Alternatively, the processes implementing methods 300 and 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, methods 300 and 400 may be performed by the kernel 140 executed by one or more processing devices of the computer system 110.

Referring to FIG. 3, at operation 310, the processing logic may identify a dataset comprising a plurality of predefined attack patterns. In one implementation, the dataset may be stored in a data store. The data store may be local or remote and may be located in a data center. In some implementations, the processing logic may identify various datasets from multiple sources, including cybersecurity conferences.

At operation 320, the processing logic may define a format for a time window. In one implementation, the processing logic may define the time window as a number representing seconds in time.

At operation 330, the processing logic may define a plurality of pattern matching approaches. In one implementation, the processing logic may define a list of pattern matching approaches, one of which can be selected for finding the pattern match. In one implementation, the processing logic may set a default pattern matching approach, for example, machine learning, text matching, or graph matching.

At operation 340, the processing logic may define a plurality of process-level remedial actions. In one implementation, the processing logic may define a list of process-level remedial actions associated with a matched attack pattern, one of which can be selected for an action. At operation 350, the processing logic may define a plurality of severity levels associated with a matched attack pattern. In one implementation, the processing logic may define a list of severity levels associated with a matched attack pattern, one of which can be selected for a corresponding mitigation measure.

Referring to FIG. 4, at operation 410, the processing logic may identify a device to monitor. In some implementations, the processing logic may identify a plurality of shells in the device for obtaining the commands, in sequence, received by each shell of the plurality of shells. At operation 420, the processing logic may determine a time window.

At operation 430, the processing logic may obtain, by a command collecting component, a sequence of commands received by the device within a specified time window. In some implementations, the command collecting component runs in an unprivileged component, wherein the unprivileged component comprises an application executed by the processing device or a virtual machine (VM) executed by the processing device.

At operation 440, the processing logic may determine a match of at least part of the sequence of commands with a predefined attack pattern. In some implementations, the predefined attack pattern is stored in a dataset of a data store, the dataset comprises a plurality of records, and each record of the plurality of records specifies a particular sequence of commands and a corresponding attack pattern. In some implementations, the processing logic may compare the commands with the sequence of commands in the dataset using a pattern matching technique. In some implementations, the pattern matching technique includes machine learning, text matching, or graph matching.

At operation 440, the processing logic may perform an action based on the predefined attack pattern. In some implementations, the processing logic may notify a user device of the match of the commands with the predefined attack pattern. In some implementations, responsive to determining the match, the processing logic may determine a value indicating a process-level remedial action. In some implementations, responsive to determining the match, the processing logic may determine a severity level of the predefined attack pattern, and determine a system-level remedial action corresponding to the severity level.

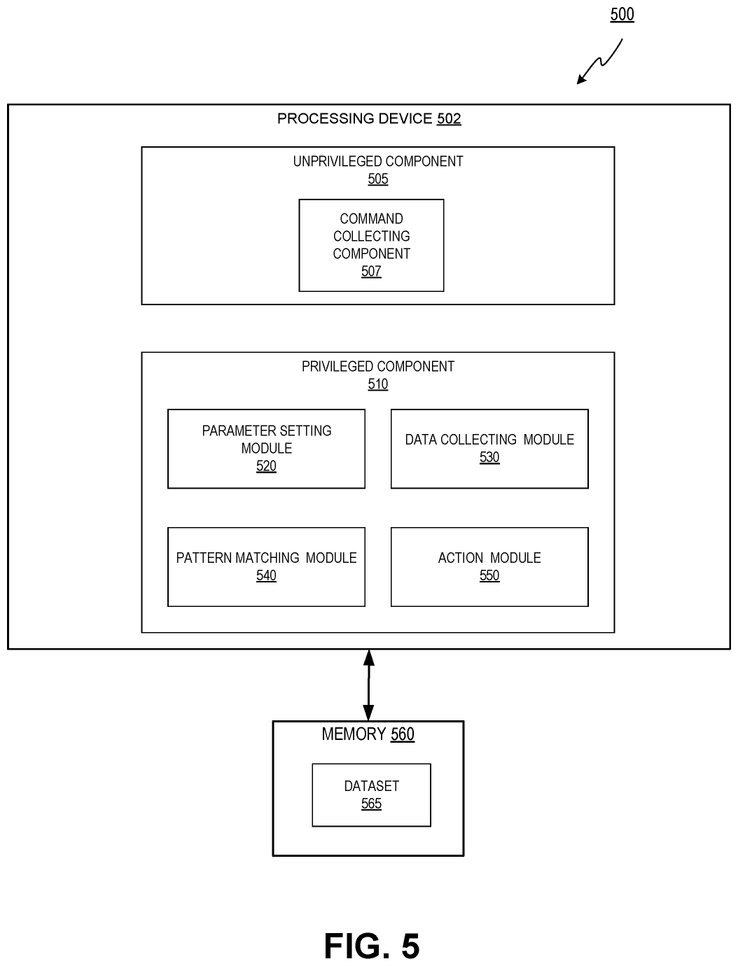

FIG. 5 depicts a block diagram of an example computer system 500, in accordance with one or more aspects of the present disclosure. Computer system 500 may be the same or similar to the computer system 110 and may include one or more processing devices 502 and one or more memory devices 560. In the example shown, the processing device 502 of the computer system 500 may include an unprivileged component 505 and a privileged component 510. Unprivileged component 505 may be same as user space 160 described with respect to FIG. 1. Privileged component 510 may be same as kernel 140 described with respect to FIG. 1.

In some implementations, the privileged component 510 may refer to a kernel of an OS or a hypervisor that manages one or more VMs. The privileged component 510 may include an opcode verifier that may perform verification of bytecode received from an unprivileged component 505 (e.g., an application, a VM, etc.) of the computing system. Bytecode may refer to a representation of a program (as a sequence of bytes). Opcode may refer to a number that represents a single instruction. The processor in a computer reads values (“machine code”) from memory and interprets these as instructions. Machine code consists of many individual instructions. Bytecode is similar to machine code. Its instructions are also represented by numbers, and the opcode identifies which instruction it is. The difference between bytecode and machine code (opcode) is that bytecode is not designed to be executed by the processor directly, but rather by another program.

The unprivileged component 505 may include a command collecting component 507. The privileged component 510 may include parameter setting module 520, data collecting module 530, pattern matching module 540, and action module 550. The privileged component 510 may execute each of parameter setting module 520, data collecting module 530, pattern matching module 540, and action module 550.

The parameter setting module 520 may setting parameters for implementing the attack pattern matching method, including the dataset including multiple predefined attack patterns, the format for the time window, the pattern matching approaches, the process-level remedial actions, or the severity levels, etc. The data collecting module 530 may receive data collected by the command collecting component 507 from an unprivileged component 505 executed by the processing device 502. Data collected by the command collecting component 507 may include the sequence of command received by each identified shell of the identified device for the time window. The pattern matching module 540 may analyze the data collected by the command collecting component 507 to determine a match of the collected data with the predefined attack pattern stored in the dataset 565 of memory 560. The action module 550 may perform, in response to determining a match of the collected data with the predefined attack pattern, an action, for example, send a notification (e.g., an alarm) of the matched attack pattern, to a user device (e.g., system administrator's device).

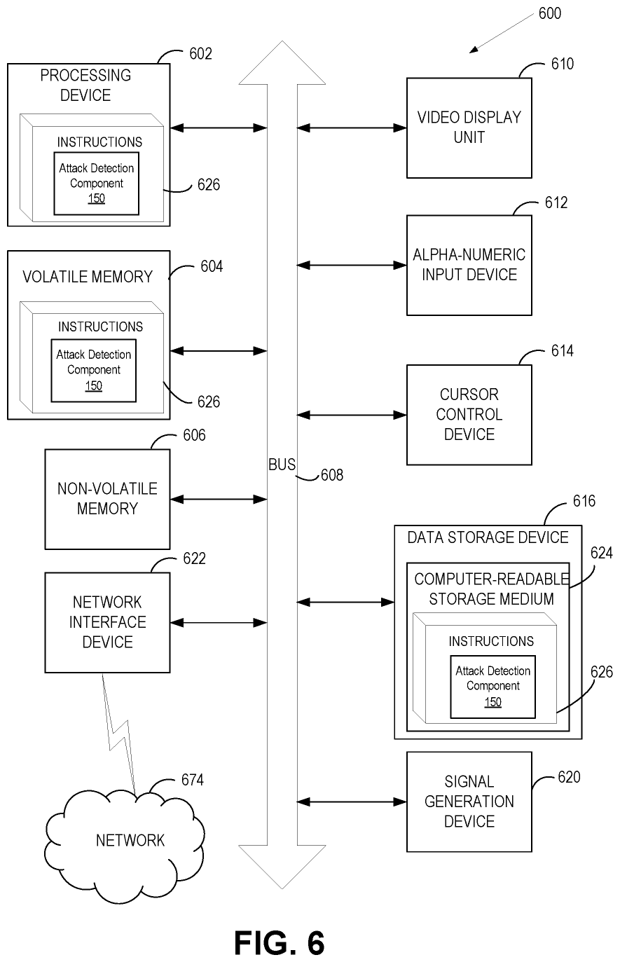

FIG. 6 depicts a block diagram of a computer system operating in accordance with one or more aspects of the present disclosure. In various illustrative examples, computer system 600 may correspond to a computing device 110 within system architecture 100 of FIG. 1. In one implementation, the computer system 600 may be the computer system 110 of FIG. 1. The computer system 600 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a host system to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions implementing method 300 and method 400 for attack detection component 150 (which may be the same as attack detection component 150 of FIG. 1) and the modules illustrated in FIG. 5.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “identifying,” “performing,” “matching,” “using,” “obtaining,” “creating,” “storing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 300 and 400, and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying, by a processing device, a sequence of commands received within a specified time window;
responsive to matching at least part of the sequence of commands to a predefined attack pattern of a plurality of predefined attack patterns, identifying a first action regarding a process associated with the at least part of the sequence of commands; and
performing the first action.

2. The method of claim 1, further comprising:
identifying a severity level associated with the predefined attack pattern; and
performing a second action associated with the severity level.

3. The method of claim 1, wherein the predefined attack pattern is stored in a data structure, wherein the data structure comprises a plurality of records, wherein each record of the plurality of records specifies a particular sequence of commands and a corresponding attack pattern.

4. The method of claim 1, wherein matching the at least part of the sequence of commands to the predefined attack pattern further comprises:
using a pattern matching technique comprising at least one of: machine learning, text matching, or graph matching.

5. The method of claim 1, further comprising:
identifying a device; and
identifying a plurality of command interfaces associated with the device, wherein identifying the sequence of commands further comprises obtaining commands received by each command interface of the plurality of command interfaces during the specified time window.

6. The method of claim 1, wherein identifying the sequence of commands is performed by an extended Berkeley packet filter (eBPF).

7. The method of claim 1, further comprising:
creating a record specifying the matched sequence of commands and the corresponding predefined attack pattern; and
storing the record in a dataset that includes the predefined attack pattern.

8. A system comprising:
a memory;
a processing device operatively coupled to the memory, the processing device to perform operations comprising:
identifying, by a processing device, a sequence of commands received within a specified time window;
responsive to matching at least part of the sequence of commands to a predefined attack pattern of a plurality of predefined attack patterns, identifying a first action regarding a process associated with the at least part of the sequence of commands; and
performing the first action.

9. The system of claim 8, wherein the operations further comprises:
identifying a severity level associated with the predefined attack pattern; and
performing a second action associated with the severity level.

10. The system of claim 8, wherein the predefined attack pattern is stored in a data structure, wherein the data structure comprises a plurality of records, wherein each record of the plurality of records specifies a particular sequence of commands and a corresponding attack pattern.

11. The system of claim 8, wherein matching the at least part of the sequence of commands to the predefined attack pattern further comprises:
using a pattern matching technique comprising at least one of: machine learning, text matching, or graph matching.

12. The system of claim 8, wherein the operations further comprises:
identifying a device; and
identifying a plurality of command interfaces associated with the device, wherein identifying the sequence of commands further comprises obtaining commands received by each command interface of the plurality of command interfaces during the specified time window.

13. The system of claim 8, wherein identifying the sequence of commands is performed by an extended Berkeley packet filter (eBPF).

14. The system of claim 8, wherein the operations further comprises:
creating a record specifying the matched sequence of commands and the corresponding predefined attack pattern; and
storing the record in a dataset that includes the predefined attack pattern.

15. A non-transitory computer-readable media storing instructions that, when executed, cause a processing device to perform operations comprising:
identifying, by a processing device, a sequence of commands received within a specified time window;
responsive to matching at least part of the sequence of commands to a predefined attack pattern of a plurality of predefined attack patterns, identifying a first action regarding a process associated with the at least part of the sequence of commands; and
performing the first action.

16. The non-transitory computer-readable media of claim 15, wherein the operations further comprises:
identifying a severity level associated with the predefined attack pattern; and
performing a second action associated with the severity level.

17. The non-transitory computer-readable media of claim 15, wherein the predefined attack pattern is stored in a data structure, wherein the data structure comprises a plurality of records, wherein each record of the plurality of records specifies a particular sequence of commands and a corresponding attack pattern.

18. The non-transitory computer-readable media of claim 15, wherein matching the at least part of the sequence of commands to the predefined attack pattern further comprises:
using a pattern matching technique comprising at least one of: machine learning, text matching, or graph matching.

19. The non-transitory computer-readable media of claim 15, wherein the operations further comprises:
identifying a device; and
identifying a plurality of command interfaces associated with the device, wherein identifying the sequence of commands further comprises obtaining commands received by each command interface of the plurality of command interfaces during the specified time window.

20. The non-transitory computer-readable media of claim 15, wherein identifying the sequence of commands is performed by an extended Berkeley packet filter (eBPF).
